(19) United States
(12) Patent Application Publication
(10) Pub. No.: US 2006/0291154 A1
(43) Pub. Date: Dec. 28, 2006

(54) GUARD SYSTEM FOR PORTABLE COMPUTER DISK DRIVE SLOT

(75) Inventors: John DiFonzo, Emerald Hills, CA (US); Chris Ligtenberg, San Carlos, CA (US)

Correspondence Address: THE LAW OFFICES OF MIKIO ISHIMARU, 333 W. EL CAMINO REAL, SUITE 330, SUNNYVALE, CA, 94087, US

(73) Assignee: APPLE COMPUTER, INC., Cupertino, CA (US)

(21) Appl. No.: 11/160,443

(22) Filed: Jun. 23, 2005

(51) Int. Cl. G06F 1/16

(52) U.S. Cl. 361/683

(57) ABSTRACT

A guard system is provided for a portable computer disk drive slot. A guard is positioned substantially adjacent the computer disk drive slot for movement between an open position and a closed position. The open position is substantially adjacent, and not obstructing access through, the disk drive slot. The closed position is substantially adjacent and across the disk drive slot, and obstructs access through the disk drive slot. The guard is positioned in the closed position across the disk drive slot for at least one of a configuration of the portable computer when the disk drive is not to be used, and a configuration of the portable computer when a disk has been loaded into the disk drive.

### TECHNICAL FIELD

The present invention relates generally to portable computers, and more particularly to a guard system for the disk drive slot in a portable computer.

### BACKGROUND ART

Computers are becoming increasingly powerful, lightweight, and portable. The computing power of computers that once filled entire rooms now resides on a desktop. Portable (e.g., “laptop”) computers are virtually as powerful as their desktop counterparts. Even smaller hand-held computers are now capable of computing tasks that required much larger computing machines just a few short years ago.

As a result, the use of personal computers is widespread and is rapidly becoming even more prevalent. Due to continuing advances in technology that have enabled the size of personal computers to decrease, the use of portable computers, particularly laptop computers, is increasing at an ever greater and greater pace.

The portability of laptop computers enables a user to keep his or her computer readily accessible such that computing resources are effectively always at hand. By way of example, a wirelessly networked portable computer running on a battery pack enables a user to access computational resources without the need for external electricity sources and free of the need to connect to wired network links. Tasks can thus be performed conveniently, at will, at virtually any location desired.

Contemporary portable computers have a lid display section that pivots or rotates with respect to a base section of the computer. The lid moves between a closed position that places the lid against the base and an open position that exposes the display screen and various components, such as the computer keyboard.

The display section includes a display screen. The base section carries various components used for operating the portable computer. These components may typically include a keyboard, a track pad or other cursor positioning device, a central processing unit (“CPU”), a power supply, memory, a floppy disk drive, a hard disk drive, an optical disk drive (“ODD”), other data storage devices, network connection and interface devices, and so forth.

The network connection and interface devices may be, for example, connectors, ports, or wireless radio devices that enable the portable computer to communicate with external sources and with peripheral devices. Such external sources and peripheral devices may be, for example, a computer network, a printer, a serial device such as a mouse, a scanner, a docking station, and so forth. Connectors or ports may also enable the portable computer to interface with a power source or power supply.

In portable computers, ODD's typically are configured as modules that are mounted within the computer base section along one side edge thereof (typically the left, front, or right side edge). Access for inserting and removing a disk (such as a compact disk (“CD”) or a digital versatile disk (“DVD”)) is then commonly provided through the adjacent side of the portable computer housing (so-called “sidewall access” or “side-access”).

In some configurations, such side-access ODD slots may have a disk carrier tray with an attached door that follows the tray to close the access slot when the tray is positioned into the interior of the portable computer. Other ODD side-access slot configurations have access openings that are protected by opposing-brush slot guards. Opposing-brush slot guards are popular for several reasons, including user preference and convenience, compactness, reduced mechanical complexity, lower cost, and protection from exposing fragile components externally, such as, for example, exposing a disk carrier tray.

Unquestionably, portable computers are subjected to a host of insults. When not in use, for example, they may be tossed into a backpack and then roughly transported in the company of various other items and debris that may be in the backpack along with the computer. This can pose significant hazards for the portable computer, even when it is turned off and closed, because even when closed and not in use, portable computers still typically have external openings that remain exposed. These openings are provided, for example, for sound speakers, electrical plugs, communication cable ports, air vents, disk drive access, and so forth.

Unfortunately, larger openings, such as ODD opposing-brush slots, may inadvertently admit detrimental and harmful foreign objects that then damage the ODD and other internal components of the portable computer. Foreign objects of this sort that have been found in portable computers include paper clips, show tickets, business cards, toothpicks, guitar picks, chewing gum wrappers, and so forth. Such foreign objects can be a more serious problem, for example, with disk drives that have disk access openings that are more exposed to such penetration, such as open slot ODD configurations that are protected by opposing-brush slot guards.

What is needed, therefore, is an uncomplicated, economical, and effective system that will enable the advantages of such opposing-brush slot disk drives to continue to be enjoyed while eliminating the disadvantages that may occur from the use of those or other such “soft” access openings for the disk drives.

Thus, a need still remains for more effective and more economical guard systems for portable computer disk drive slots. In view of the ever increasing commercial competitive pressures, increasing consumer expectations, and diminishing opportunities for meaningful product differentiation in the marketplace, it is increasingly critical that answers be found to these problems. Moreover, the ever-increasing need to save costs, improve efficiencies, reduce machine failures, and meet such competitive pressures adds even greater urgency to the critical necessity that answers be found to these problems.

Solutions to these problems have been long sought but prior developments have not taught or suggested any solutions and, thus, solutions to these problems have long eluded those skilled in the art.

### DISCLOSURE OF THE INVENTION

The present invention provides a guard system for a portable computer disk drive slot. A guard is positioned substantially adjacent the computer disk drive slot for movement between an open position and a closed position. The open position is substantially adjacent, and not obstructing access through, the disk drive slot. The closed position is substantially adjacent and across the disk drive slot, and obstructs access through the disk drive slot. The guard is positioned in the closed position across the disk drive slot for at least one of a configuration of the portable computer when the disk drive is not to be used, and a configuration of the portable computer when a disk has been loaded into the disk drive.

Certain embodiments of the invention have other advantages in addition to or in place of those mentioned above. The advantages will become apparent to those skilled in the art from a reading of the following detailed description when taken with reference to the accompanying drawings.

### BRIEF DESCRIPTION OF THE DRAWINGS

FIG. 1 is a view of a portable computer with a housing base and an optical disk drive;

FIG. 2 is a view, facing toward the slot shown in FIG. 1, of the optical disk drive of FIG. 1 with the guard actuated to an open position;

FIG. 3 is a view, similar to FIG. 2, of the optical disk drive of FIG. 1 with the guard actuated to a closed position;

FIG. 4 is a cross-sectional view of a portion of the structure of FIG. 1 taken generally on line 4-4 in FIG. 1, showing the guard in the open position;

FIG. 5 is a view similar to the structure of FIG. 4 showing the guard in the closed position; and

FIG. 6 is a flow chart of a guard system for a portable computer disk drive slot in accordance with an embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and operational steps are not disclosed in detail.

Likewise, the drawings showing embodiments of the devices are semi-diagrammatic and not to scale and, particularly, some of the dimensions are for the clarity of presentation and are shown exaggerated in the drawing FIGs. Also, where multiple embodiments are disclosed and described having some features in common, for clarity and ease of illustration, description, and comprehension thereof, similar and like features one to another will ordinarily be described with like reference numerals.

The term “horizontal” as used herein is defined as a plane parallel to the bottom plane or surface of the portable computer when it is in its ordinary operating position with the bottom surface lowermost, below the keyboard. The term “vertical” refers to a direction perpendicular to the horizontal as just defined. Terms, such as “on”, “above”, “below”, “bottom”, “top”, “side” (as in “sidewall”), “higher”, “lower”, “upper”, “over”, and “under”, are defined with respect to the horizontal plane, unless understood otherwise within and as a result of a particular context.

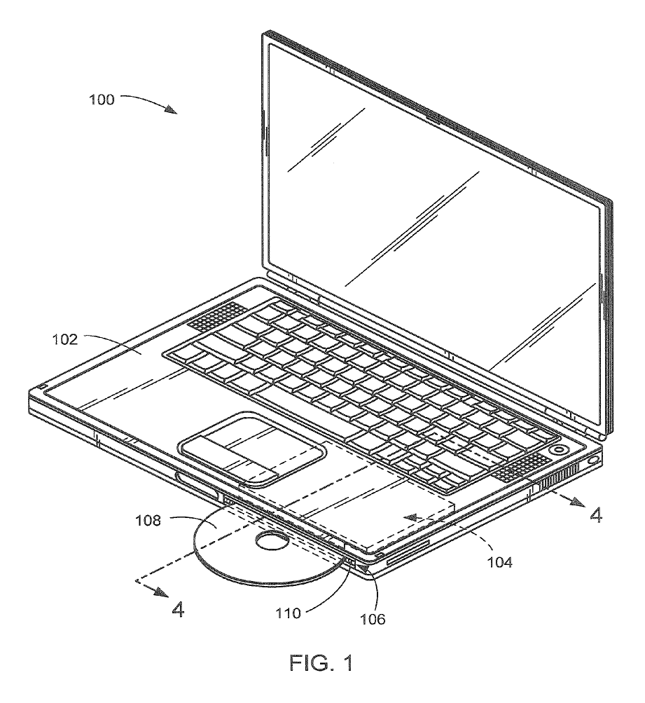

Referring now to FIG. 1, therein is shown a portable computer 100 having a housing base 102 in which an optical disk drive (“ODD”) 104 is supported adjacent a slot 106 for receiving a disk 108 therethrough. The slot 106 is protected by a brush slot guard 110. The brush slot guard 110 is a pair of opposing brushes, facing and generally touching one another, through which the disk 108 passes upon insertion into and ejection from the ODD 104.

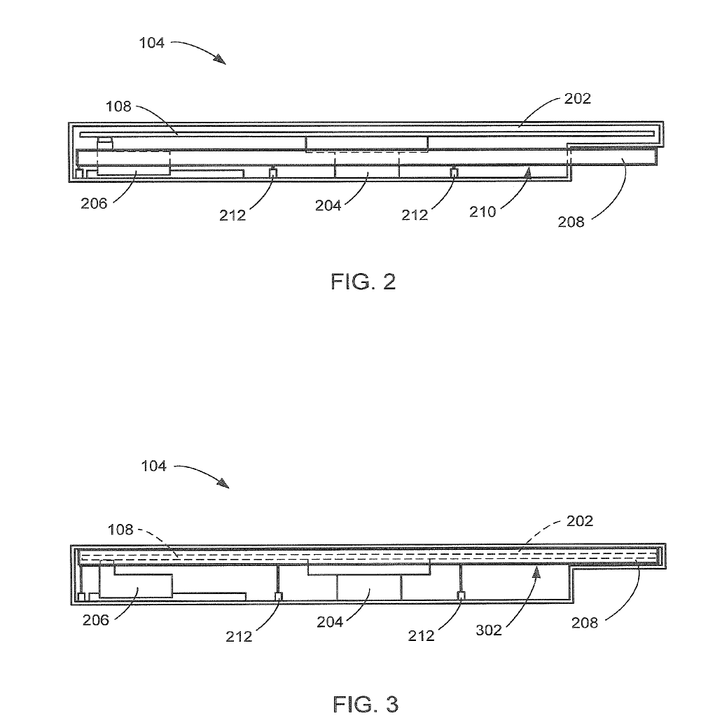

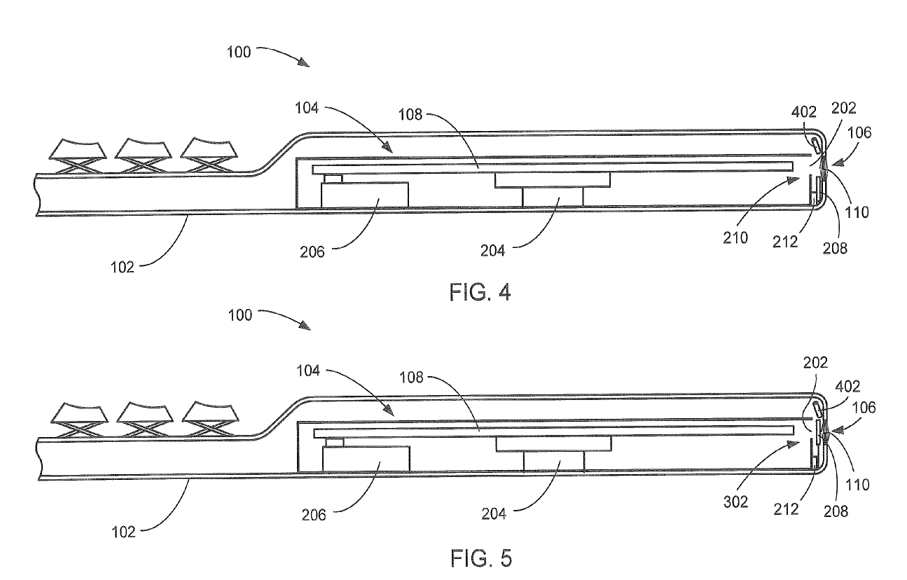

Referring now to FIG. 2, therein is shown the ODD 104 (FIG. 1) as viewed facing toward the slot 106 (FIG. 1). The ODD 104 is positioned directly behind the slot 106 and has an opening 202 that is aligned with the slot 106 (as may be seen in FIGS. 4 and 5). Upon insertion through the slot 106, the disk 108 is received into the ODD 104 through the opening 202 therein.

Following insertion of the disk 108 into the ODD 104, the disk 108 is engaged by a motor 204 that rotates the disk. The information on the disk is then read by a laser sensor 206.

It has been unexpectedly discovered that the opening 202 into the ODD 104 can be protected from unauthorized intrusion of foreign objects, according to the present invention, by a guard 208. The guard 208, which in one embodiment is substantially imperforate, is supported for movement from an open position 210 (as shown in FIG. 2) that reveals the opening 202, to a closed position 302 (as shown in FIG. 3) that covers and blocks the opening 202. Movement of the guard 208 between the open and closed positions 210 and 302 is effected by and under the control of guard positioners 212. In one embodiment, the guard positioners 212 may be latching solenoids; in another, reversible motors. Other forms of guard positioners may also be used as desired or appropriate for the particular application and configuration that may be at hand.

Referring now to FIG. 3, therein is shown the ODD 104 with the guard 208 actuated by the guard positioners 212 to the closed position 302 covering the opening 202.

Referring now to FIG. 4, therein is shown a cross-sectional view of a portion of the portable computer 100, taken generally on line 4-4 in FIG. 1. The guard 208 is shown in the open position 210 permitting access through the slot 106 in the housing base 102 of the portable computer 100 into the opening 202 of the ODD 104. A disk, for example the disk 108, has been inserted between the brush slot guards 110 at the slot 106 and into the ODD 104 where it has been engaged by the motor 204. A sensor 402, such as a photosensor, is mounted adjacent the slot 106, as will be described in greater detail hereinbelow.

Referring now to FIG. 5, therein is shown a view, similar to FIG. 4, of the portable computer 100 except that the guard 208 has been actuated to the closed position 302. In the closed position 302, the guard 208 protects and blocks access to the opening 202 through the slot 106.

As thus shown in FIGS. 4 and 5, the guard 208 in this embodiment is positioned substantially adjacent the inside of the slot 106 for vertical movement next thereto. The vertical movement is between the open position 210 substantially adjacent and not obstructing access through the slot 106 (FIG. 4), and the closed position 302 substantially adjacent and across the inside of substantially the entire slot 106 and obstructing access therethrough (FIG. 5). When in the closed position 302, the guard 208 prevents insertion of and blocks foreign objects from entering the ODD 104 in the portable computer 100 through the slot 106 for the ODD 104. Thus, as described further hereinbelow, the guard 208 in the closed position 302 across the slot 106 prevents insertion of foreign objects, for example, during a configuration of the portable computer 100 when the ODD 104 is not to be used, and/or during a configuration of the portable computer 100 when a disk, such as the disk 108, has already been loaded into the ODD 104.

Based on this disclosure, several ways for controlling the guard 208 to prevent foreign objects from entering the ODD 104 will now be clear to one of ordinary skill in the art. In one embodiment, for example, the guard 208 will be kept in the closed position 302 at all times (including when the portable computer 100 is turned off), with the only exception being for and during access to the ODD 104 for insertion and removal of the disk 108.

In another embodiment, the guard 208 will be closed and thereby fully block the slot 106 and the opening 202 only when the portable computer 100 is in a non-operating, powered down, energy saving state (e.g., turned off, “asleep”, or “hibernating”), and thus in a configuration when the ODD 104 is not going to be used. Conversely, the guard 208 will be open when the portable computer 100 is in a configuration wherein it is on and operational. Such an embodiment is relatively uncomplicated to implement and prevents foreign objects from entering the ODD 104 during those times when foreign objects are most likely to enter the ODD 104. That is, the ODD 104 is more likely to be exposed to intrusion from foreign objects when the portable computer 100 is in a configuration in which it is not to be used (e.g., when the computer may be in a backpack or a briefcase, or stored somewhere else).

In another embodiment, the guard 208 may be maintained in the closed position 302 until the user requests access to the ODD 104, such as by touching or pressing an eject key or a disk access button.

In yet another embodiment, a sensor, such as the sensor 402, can be configured and utilized to detect the presence of a disk at the middle of the slot 106, and upon detecting such a disk insertion attempt, to actuate the guard positioners 212 to open the guard 208 by positioning the guard 208 to the open position 210.

In still another embodiment, similar to the one just described, the sensor 402 may be configured and utilized for detecting and admitting only objects that are reflective, for example on the bottom surface, which is typical of optical disks but atypical of the majority of other objects. In that case, it will be clear to one of ordinary skill in the art that the sensors 402 would include one or more sensors below the slot 106, rather than or in addition to the sensor 402 that is illustrated in FIGS. 4 and 5 above the slot 106, to sense the reflectivity of the bottom of the disk 108. Then, upon detecting a disk insertion attempt, such as at the middle of the slot 106, the guard will be positioned into the open position 210 in response thereto.

In another embodiment, the guard positioners 212 may be configured to position the guard 208 in the closed position 302 across the slot 106 for the ODD 104 when the configuration of the portable computer 100 is an orientation thereof that exceeds a set threshold from a horizontal orientation.

Based on this disclosure, it will now be clear to one of ordinary skill in the art that the various functions and activities described above may all be under the control of the customary computer circuitry, such as a CPU, ram, and so forth, that is found in laptop computers, and such circuitry is therefore also comprehended by reference to the portable computer 100 itself. Likewise, the guard positioners 212, under the control of the computer circuitry, are thereby configured for positioning the guard in the open and closed positions according to the various conditions and configurations of the portable computer as disclosed above.

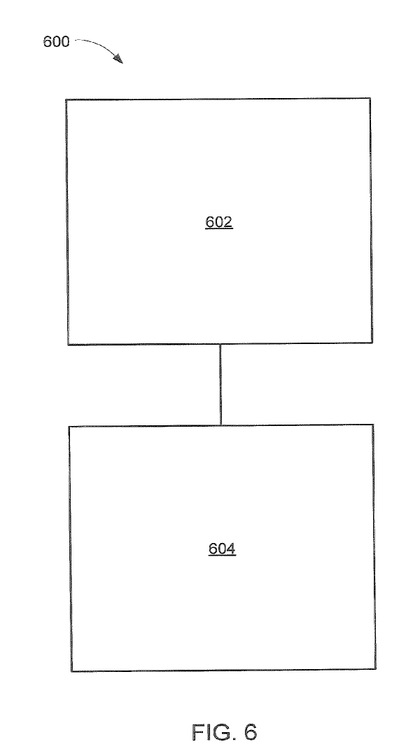

Referring now to FIG. 6, therein is shown a flow chart of a guard system 600 for a portable computer disk drive slot in accordance with an embodiment of the present invention. The system 600 includes positioning a guard substantially adjacent the computer disk drive slot for movement between an open position substantially adjacent, and not obstructing access through, the disk drive slot, and a closed position substantially adjacent and across the disk drive slot, and obstructing access therethrough, in a block 602; and positioning the guard in the closed position across the disk drive slot for at least one of a configuration of the portable computer when the disk drive is not to be used, and a configuration of the portable computer when a disk has been loaded into the disk drive, in a block 604.

It has been discovered that the present invention thus has numerous advantages.

A principle advantage is that the present invention provides a more effective and more economical guard system for portable computer disk drive slots.

Another advantage of the present invention is that it enables the advantages of opposing-brush slot guard access configurations to continue to be enjoyed while eliminating intrusion disadvantages that may occur from the use of such “soft” access openings for the disk drives.

Another advantage of the present invention is that it is uncomplicated, yet highly effective in preventing unwanted foreign objects from entering the disk drive of a portable computer.

Still another advantage is that the invention can be inexpensively yet very effectively implemented simply by closing the guard when the computer is shut down or asleep, and opening the guard when the computer is awake and/or in use.

Yet another advantage of the present invention is that it can be configured for more restrictive access to the ODD, such as in response to a user request, and/or in response to attempted disk insertion.

Still another advantage is that the present invention can be configured to discriminate between acceptable and unacceptable objects during attempted insertion, for example, by detecting the presence or absence of a reflective surface, such as the bottom surface, on the object.

Yet another important advantage of the present invention is that it valuably supports and services the historical trend of reducing costs, simplifying systems, and increasing performance.

These and other valuable aspects of the present invention consequently further the state of the technology to at least the next level.

Thus, it has been discovered that the guard system of the present invention for a portable computer disk drive slot furnishes important and heretofore unknown and unavailable solutions, capabilities, and functional advantages for disk drives used in portable computers. The resulting configurations are straightforward, cost-effective, uncomplicated, highly versatile and effective, can be implemented by adapting known technologies, and are thus readily suited for efficiently and economically manufacturing robust disk drive devices for portable computers.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations which fall within the scope of the included claims. All matters hithertofore set forth herein or shown in the accompanying drawings are to be interpreted in an illustrative and non-limiting sense.

What is claimed is:

1. A guard system for a portable computer disk drive slot, comprising:
positioning a guard substantially adjacent the computer disk drive slot for movement between:
an open position substantially adjacent, and not obstructing access through, the disk drive slot; and
a closed position substantially adjacent and across the disk drive slot, and obstructing access therethrough; and
positioning the guard in the closed position across the disk drive slot for at least one of: a configuration of the portable computer when the disk drive is not to be used; and
a configuration of the portable computer when a disk has been loaded into the disk drive.

2. The system of claim 1 wherein positioning a guard further comprises positioning a guard that is substantially imperforate.

3. The system of claim 1 wherein positioning the guard in the closed position further comprises positioning the guard across the disk drive slot when the computer is powered down.

4. The system of claim 1 wherein positioning the guard in the closed position further comprises positioning the guard across the disk drive slot when the configuration of the portable computer is an orientation thereof that exceeds a predetermined threshold from a horizontal orientation.

5. The system of claim 1 further comprising detecting a disk insertion attempt and positioning the guard in the open position in response thereto.

6. The system of claim 1 further comprising, with a sensor that detects the presence of a disk at the disk drive slot, detecting a disk insertion attempt and positioning the guard in the open position in response thereto.

7. The system of claim 1 further comprising, with a sensor that detects the presence of a disk at the disk drive slot by detecting objects that are reflective on at least one surface thereof, detecting a disk insertion attempt and positioning the guard in the open position in response thereto.

8. The system of claim 1 further comprising protecting the disk drive slot with a brush slot guard.

9. A guard system for a portable computer disk drive slot, comprising:
positioning a guard adjacent the inside of the computer disk drive slot for vertical movement between:
an open position adjacent, and not obstructing access through, the disk drive slot; and
a closed position adjacent and across the inside of substantially the entire disk drive slot, and obstructing access therethrough, to block foreign objects from entering through the disk drive slot into an optical disk drive in the portable computer; and
positioning the guard in the closed position across the disk drive slot, to prevent insertion of foreign objects thereinto, for at least one of:
a configuration of the portable computer when the optical disk drive is not to be used; and
a configuration of the portable computer when a disk has been loaded into the optical disk drive.

10. The system of claim 9 wherein positioning a guard further comprises positioning a guard that is substantially imperforate.

11. The system of claim 9 wherein positioning the guard in the closed position further comprises positioning the guard across the disk drive slot at least when the computer is powered down, turned off, asleep, or hibernating.

12. The system of claim 9 wherein positioning the guard in the closed position further comprises positioning the guard across the disk drive slot when the configuration of the portable computer is an orientation thereof that exceeds a predetermined threshold from a horizontal orientation.

13. The system of claim 9 further comprising detecting a disk insertion attempt and positioning the guard in the open position in response thereto.

14. The system of claim 9 further comprising, with a photosensor that detects the presence of a disk at the middle of the disk drive slot, detecting a disk insertion attempt and positioning the guard in the open position in response thereto.

15. The system of claim 9 further comprising, with a photosensor that detects the presence of a disk at the middle of the disk drive slot by detecting objects that are reflective on the bottom surface thereof, detecting a disk insertion attempt and positioning the guard in the open position in response thereto.

16. The system of claim 9 further comprising protecting the disk drive slot with a brush slot guard.

17. A guard system for a portable computer disk drive slot, comprising:
a guard positioned substantially adjacent the computer disk drive slot for movement between:
an open position substantially adjacent, and not obstructing access through, the disk drive slot; and
a closed position substantially adjacent and across the disk drive slot, and obstructing access therethrough; and
a guard positioner configured for positioning the guard in the closed position across the disk drive slot for at least one of:
a configuration of the portable computer when the disk drive is not to be used; and
a configuration of the portable computer when a disk has been loaded into the disk drive.

18. The system of claim 17 wherein the guard further comprises a guard that is substantially imperforate.

19. The system of claim 17 wherein the guard positioner further comprises a guard positioner that is configured for positioning the guard across the disk drive slot when the computer is powered down.

20. The system of claim 17 wherein the guard positioner further comprises a guard positioner that is configured for positioning the guard across the disk drive slot when the configuration of the portable computer is an orientation thereof that exceeds a predetermined threshold from a horizontal orientation.

21. The system of claim 17 further comprising a sensor configured for:
detecting a disk insertion attempt; and
actuating the guard positioner to position the guard in the open position in response to such a disk insertion attempt.

22. The system of claim 17 further comprising a sensor configured for:
detecting a disk insertion attempt by detecting the presence of a disk at the disk drive slot, and
actuating the guard positioner to position the guard in the open position in response to such a disk insertion attempt.

23. The system of claim 17 further comprising a sensor configured for:
detecting a disk insertion attempt by detecting the presence of a disk at the disk drive slot by detecting objects that are reflective on at least one surface thereof; and
actuating the guard positioner to position the guard in the open position in response to such a disk insertion attempt.

24. The system of claim 17 further comprising a brush slot guard protecting the disk drive slot.

25. A guard system for a portable computer disk drive slot, comprising:
a guard positioned adjacent the inside of the computer disk drive slot for vertical movement between:
an open position adjacent, and not obstructing access through, the disk drive slot; and
a closed position adjacent and across the inside of substantially the entire disk drive slot, and obstructing access therethrough, to block foreign objects from entering through the disk drive slot into an optical disk drive in the portable computer; and
a guard positioner configured for positioning the guard in the closed position across the disk drive slot, to prevent insertion of foreign objects thereinto, for at least one of:
a configuration of the portable computer when the optical disk drive is not to be used; and
a configuration of the portable computer when a disk has been loaded into the optical disk drive.

26. The system of claim 25 wherein the guard further comprises a guard that is substantially imperforate.

27. The system of claim 25 wherein the guard positioner further comprises a guard positioner that is configured for positioning the guard across the disk drive slot at least when the computer is powered down, turned off, asleep, or hibernating.

28. The system of claim 25 wherein the guard positioner further comprises a guard positioner that is configured for positioning the guard across the disk drive slot when the configuration of the portable computer is an orientation thereof that exceeds a predetermined threshold from a horizontal orientation.

29. The system of claim 25 further comprising a photosensor configured for:
detecting a disk insertion attempt; and
actuating the guard positioner to position the guard in the open position in response to such a disk insertion attempt.

30. The system of claim 25 further comprising a photosensor configured for:
detecting a disk insertion attempt by detecting the presence of a disk at the middle of the disk drive slot, and
actuating the guard positioner to position the guard in the open position in response to such a disk insertion attempt.

31. The system of claim 25 further comprising a photosensor configured for:
detecting a disk insertion attempt by detecting the presence of a disk at the middle of the disk drive slot by detecting objects that are reflective on the bottom surface thereof; and
actuating the guard positioner to position the guard in the open position in response to such a disk insertion attempt.

32. The system of claim 25 further comprising a brush slot guard protecting the disk drive slot.
